(19) United States
(12) Patent Application Publication
(10) Pub. No.: US 2003/0121532 A1
(43) Pub. Date: Jul. 3, 2003

(54) Removal of biofilm from surfaces

(76) Inventors: Robert W. Coughlin, Storrs, CT (US); Wafaa M. Mahmoud, Wallingford, CT (US); Edward M. Davis, Torrington, CT (US); Heather L. Reddy, Denver, CO (US)

Correspondence Address: Robert W. Coughlin, 49 STORRS HEIGHTS ROAD, STORRS, CT, 06268, US

(21) Appl. No.: 10/268,582

(22) Filed: Oct. 10, 2002

Related U.S. Application Data
(60) Provisional application No. 60/328,580, filed on Oct. 11, 2001.

(51) Int. Cl. B08B 7/00; B08B 9/00; C09K 3/00; B01F 3/12; B01F 17/00; B08B 3/00; C11D 1/00; C23G 1/00; C02F 5/08

(52) U.S. Cl. 134/7; 134/22.12; 134/169 R; 134/169 C; 510/247; 516/77; 516/88

(57) ABSTRACT

The disclosure encompasses composition, method and apparatus that provide improved and convenient removal of biofilm from surfaces. Surfaces cleaned according to the invention comprise the inner wall of conduits such as those employed in dental clinics, food and pharmaceutical manufacturing.

### PRIORITY CLAIM

This application claims the benefit of Provisional Application No. 60/328,580 filed by the same inventive entity in the USPTO on Oct. 11, 2001.

### FEDERALLY SPONSORED R&D

The U.S. Federal government has certain rights regarding this invention which is based in part on research conducted under a grant from the U.S. National Institutes of Health.

### BACKGROUND OF THE INVENTION

Biofilms are complex microbial communities embedded in a protective matrix that is largely a polysaccharide slime excreted by the microbes. Biofilms form spontaneously and deposit on surfaces in most aqueous environments. Many people can recall experience of a biofilm in the form of a slime layer on a stone plucked from a brook or as a film of plaque removed from their teeth by cleaning at a dentist's office. The matrix (sometimes called glycocalix) of a biofilm protects the organisms within from biocides, predation, dehydration and attack by immune systems (in the case of biofilms on plant or animal tissue). Biofilms are very frequently undesirable because they can include pathogenic microorganisms that are possible dangerous infectious agents. Undesirable biofilms form on implants or indwelling devices within the human body such as sutures, catheters, stents, artificial hearts, artificial joints, pacemakers and similar devices. Biofilms on the surfaces of cooling towers and chilled-water air-conditioning systems have been found to harbor Legionella, pseudomonads and other infectious pathogenic organisms. Potentially dangerous biofilms have been found to form regularly on the inner surfaces of the conduits of the dental units that provide water to patients in dental offices and clinics. Biofilm contamination forms on medical devices such as endoscopes during use.

Clearly there is need for methods of removing undesirable biofilm which is difficult to remove. Often, after attempts to remove it, small fragments of lingering biofilm left behind harbors viable microorganisms which can provide microbial inoculation that speeds re-growth of biofilm. Because the polysaccharide matrix of biofilm provides a barrier which protects microbes which inhabit, it is difficult to kill the microorganisms by applying biocides or antibiotic agents.

### DISCUSSION OF THE BACKGROUND ART

The problems of biofilm, and the need to control and remove biofilm, are illustrated by biofilm that develops within water lines in clinical dental units (DU). The problems associated with biofilm in water lines in clinical dental systems are typical and illustrative of biofilm problems that occur in cleaning medical devices, cleaning conduits and processing apparatus in the food, water treatment and pharmaceutical industries, or in any industry that employs water. Biofilm problems in dental unit water lines (DUWLs) within dental unit water systems (DUWSs) are next discussed in detail for illustrative purposes.

A majority of the dental offices in the United States and throughout the world have biofilms and associated microbial contamination of their dental treatment water. Biofilm formation on the water-contacting surfaces of dental delivery units results in widespread microbial contamination. In a typical report by Clinical Research Associates (CRA, 1997), measured microbial populations were only about 2-10 cfu/ml in the faucet water supply to a DU, but as great as 10,000 to 400,000 in water discharged from the DU air-water syringe and handpiece. Numerous studies, (e.g., see Shearer, 1996) for a recent review), have revealed much about the extent and seriousness of the effect of DUWS-biofilms on both patients and practitioners. Seventy-two percent of water samples from dental unit water lines (DUWL) in eleven dental offices contained bacterial populations that would qualify them as unfit for human consumption (criterion: 500 colony-forming units per mL (cfu/mL)) (Williams, et al., 1993). Mean heterotrophic counts were 49,700 cfu/ml. In contrast, faucet water qualified as unfit for consumption in only one of the eleven offices. The source of the contamination was originally thought to be normal oral flora (Bagga, et al., 1984). It was later demonstrated, however, that the contamination is attributable to microbes sloughing from the biofilms that flourish on the walls of the DUWLs into the treatment-water flowing through the lumens of the DUWLs (Williams, et al., 1995).

Walker et al. (2000) studied water obtained from DUWLs in 55 dental clinics in England and found that the water delivered to patients contained “microbial levels exceeding those considered safe for drinking water”. Karpay et al. (1999) combined continuous and periodic treatment using hypochlorite solution but, using this protocol, these workers were unable to achieve satisfactory biofilm removal from four out of ten DUWL systems studied.

The clinical problem with contaminated treatment-water is that the contaminating microbes can be highly enriched for both opportunistic and primary pathogenic bacteria (Shearer, 1996). The presence of these pathogens presents two complications for the dental practitioner. First, patients with actual or potential immune dysfunction, (e.g., AIDS patients, cancer patients, the elderly, diabetics and cystic fibrosis patients) are at increased risk of morbidity associated with infections caused by contaminated treatment-water. Second, dentists and their staffs have been shown to be seropositive to DUWL-associated microbes (Fotos, et al., 1985). Clearly dental treatment-water contamination can adversely impact both patient and care-giver. A recent review (Mills 2000) provides a practical overview of the problem, various attempts to solve it and clinical implications of the problem.

Biofilms

Microbes that form biofilms in DUWSs originate from the public and private water sources that supply the DUWSs. Generally, DUWS-associated biofilms are mature, dynamic, biological systems with a thickness of 30 to 50 microns. They consist of a heterogeneous mixture of bacteria, fungi and protozoa encased in a glycocalyx, or exopolysaccharide (EPS) coating (Costerton, et al., 1995, Massol-Deya, et al., 1994, Tall, et al., 1995, Williams, et al., 1993). As the source water, which is generally only slightly contaminated (i.e., <500 cfu/mL), passes through the lumens of the DUWLs, the conduit walls of the DUWLs are conditioned by components and colonized by microbes found in the source water. Over the next 1 to 6 months following colonization, a mature biofilm forms (Costerton, et al., 1995). As the biofilm develops, microbes and microbial aggregates slough into the treatment water, thereby contaminating it (Kelstrup, et al., 1977, Shearer, 1996). Plateau levels of treatment-water contamination from newly-installed DUWLs can be reached, however, by 5 to 7 days after installation (Barbeau, et al., 1996). This sloughing process is a phenomenon intrinsic to established biofilms and represents the dynamic balance between the growth of new biofilm material and the detachment of old material (Boyd and Charkrabarty, 1995, Williams, et al., 1995).

Adhesion of microorganisms to a solid surface is believed to occur by a succession of events beginning with adsorption of macromolecules, and continuing with attachment of cells and changes in free-living microbial populations proximate to the surface (Beachy, 1981). Colonies of pseudomonads on the surface of PVC were reported to be protected from antimicrobial disinfectants by biofilm (sometimes called glycocalyx) in which the cells are embedded (Anderson, et al., 1990). Costerton et al. (Costerton, et al., 1987, Costerton, et al., 1995) have pointed out that planktonic and sessile cells differ in metabolism, the sessile being more productive in that they synthesize the exopolysaccharidic matrix of biofilm (Davies, et al., 1993, Vandevivere and Kirchman, 1993).

A recent paper (Meiller et al. 1999) reports on attempts to remove biofilms from DUWLs using sodium hypochlorite, glutaraldehyde or isopropanol. After treatment with hypochlorite or isopropanol, bacteria in effluent and biofilm reverted to pretreatment levels by day 6 and day 15 respectively. Such reversions to flourishing biofilm and bacterial count in effluent water occurred by day 3 after treatment with glutaraldehyde. Multiple treatments were able to control the bacterial level in the water but failed to remove the biofilm matrix on the wall of the tubing. Meiller et al. (1999) suggest that the remnant matrix plays a role in the rapid re-growth of the biofilm.

Microbial Assessment of Biofilms

Biofilm structure and microorganisms can be examined by many techniques. Some techniques involve dispersal of the biofilm; others involve examination of the entire biofilm structure (An and Friedman, 1997). Biofilm can be removed from a sample surface by sonication, homogenization, or the use of surfactants. Sonication is reported to be an effective method for enumeration of biofilm bacteria and is as effective as homogenization (Bergamini, et al., 1989, McDaniel and Capone, 1985, Tollefson, et al., 1987), while having less potential for harming the microorganisms than surfactant. Scraping removes biofilm well, after which it is dispersed by mixing (Tall, et al., 1995, Wellman, et al., 1996).

Once the microbes and biofilm have been removed from the surface, the microbes can be counted by microscopy (An and Friedman, 1997, Tang and Cooney, 1998). Viable bacteria can be counted with plate counts (Tall, et al., 1995, Tang and Cooney, 1998, Wellman, et al., 1996), radiolabelling, or CTC staining (An and Friedman, 1997).

To assess the characteristics of the intact biofilm, different types of microscopy have been used. Both transmission electron microscopy (TEM) and scanning electron microscopy (SEM) can provide valuable structural information, but careful preparation of the samples is necessary to avoid deformation of the biofilm (Gristina and Costerton, 1984). Biofilm structure can also be observed with scanning confocal laser microscopy (SCLM) (Qian, et al., 1996), nuclear magnetic resonance (NMR) and attenuated-total-reflection/Fourier-transform-infrared-spectroscopy (ATR-FTIR) (An and Friedman, 1997).

Biofilm Removal Techniques

Although the potential pathological significance of biofilms that form on solid surfaces has been appreciated for at least a decade, little progress has been made in developing new technology for biofilm eradication. Application of biocides and antibiotics generally leaves behind viable microorganisms within the protective polysaccharide matrix of the biofilms. Chemical agents sufficiently aggressive to completely destroy biofilm can also attack the underlying solid surface and cause costly destruction in expensive systems such as DUWSs. For decades, the most effective approach to controlling a biofilm familiar to man (dental plaque) has been mechanical disruption by brushing the teeth. No widely accepted rinse or irrigation has yet been found to replace the mechanical action of brushing as the best known means of controlling dental plaque.

Generally, it has been found that merely flushing DUWLs with water is inadequate to control microbial contamination. The literature on decontamination of DUWSs has recently been reviewed by Fayle and Pollard (Fayle and Pollard, 1996). They concluded that no single method or device is sufficient to eliminate the problem, that flushing DUWSs between patients can be efficient in reducing, but not eliminating, treatment water contamination, that so called “clean water” units were efficient, but required strict adherence to the manufacturer's decontamination protocol, and that further efforts were needed to solve the problem. Although the bacteria-laden luminal fluid may be removed from a DUWL by flushing, rapid replenishment of bacteria in the fresh replacement water arises from the biofilm adhering to the walls of the tubing. At best, flushing is a temporary solution (Williams, et al., 1995) and requires 8 minutes to be effective (Barbeau, et al., 1996). The effects of flushing the DUWLs can be enhanced with the addition of chemically active substances. Jacqueline et al. (Jacqueline, et al., 1994) have described the removal of an E. coli biofilm by the combined action of an enzyme, a disinfectant and a surfactant. DeBeer et al (DeBeer, et al., 1994) reported only limited penetration of waterline biofilm by chlorine. Moussa et al (Moussa, et al., 1996) observed that benzalkonium chloride is effective for removing adherent bacteria from orthopedic hardware.

The nature of DUWL biofilms before and after cleaning has been investigated microscopically with Nomarski optics (Williams, et al., 1993) and with SEM (Williams, et al., 1995). Although disinfection by bleach (Williams, et al., 1994) has been reported to be effective at least temporarily in eliminating recoverable bacterial colony forming units (cfu) from DUWLs, SEM examination of the luminal walls of the tubing (Williams, et al., 1995) revealed that the biofilms remained intact after disinfection by bleach. The use of bleach solution is an approach recommended by at least one manufacturer (A-dec Corporation, 1995), although this procedure can cause aggressive corrosion of metal fittings and related system parts depending on water conditions such as pH, ionic strength and oxygen tension. A gentler method is therefore desirable from a corrosion-prevention standpoint.

Better, simpler control and prevention or elimination of microbial biofilm in DUWLs is needed. It is desirable that methods of control, prevention and elimination of biofilm insure that the microbial concentration in the water delivered not exceed the ADA recommendation of 200 cfu/mL. It is also desirable that such methods be compatible with dental restorative materials and not employ potentially toxic or carcinogenic chemicals. Moreover, any technology to be considered for biofilm removal should cause no harm to dental unit (DU) equipment and systems and it should also do no harm when applied to any other surface to be cleaned.

A number of U.S. Patents disclose a variety of compositions for removing biofilm from surfaces. Use of compositions containing enzymes is disclosed in U.S. Pat. Nos. 6,100,080; 5,411,666; 4,936,994; 4,994,390. U.S. Pat. No. 6,080,323 discloses addition of an alkyl polyglycoside to water to promote removal of biofilm from submerged surfaces. U.S. Pat. No. 6,096,225 discloses use of an aqueous medium containing an oil-in-water emulsion comprising an antimicrobial oil phase and at least one emulsifier. U.S. Pat. No. 6,106,854 discloses a disinfectant composition comprising seven or more different types of ingredients. U.S. Pat. No. 4,214,871 discloses the use of non-abrasive solid pellets entrained in a liquid jet for cleaning teeth. U.S. Pat. No. 5,922,745 discloses a composition for inhibiting microbial growth comprising stabilized sodium hypobromite and isothiazolones. U.S. Pat. No. 5,910,420 discloses compositions for pre-treating surfaces prior to sampling for microbial analysis.

Various electrical methods have also been disclosed for reducing biofilm on surfaces, for example, in U.S. Pat. Nos. 5,312,813; 5,462,644; 6,004,438.

All of the U.S. patents cited above are incorporated herein by reference.

### ADVANTAGES OF THE INVENTION

The present invention provides a far simpler and more effective method for removing biofilm, especially from the difficult-to-access inner wall of conduits. The present invention also provides improved compositions and methods for removing biofilm from the inner wall of conduits that are far simpler, less complex and more convenient than those heretofore known.

### DESCRIPTION OF THE DRAWING FIGURES

FIG. 1 shows an apparatus for cleaning the inside surface of a tubular conduit using a slurry or suspension of particles in a liquid according to the instant invention. FIG. 1A shows apparatus according to the instant invention in which a slurry comprising particles and liquid is pumped into another liquid flowing in a conduit to be cleaned.

FIG. 2 shows apparatus according to the instant invention in which a slurry comprising particles and liquid is maintained in suspension by a pump-around system.

FIG. 3 shows apparatus according to the instant invention in which a pressurized water supply is utilized to cause flow through a conduit of a slurry comprising particles and liquid.

### OBJECTS OF THE INVENTION

An object of the invention is to provide an improved method of removing biofilm from solid surfaces.

Another object of the invention is to provide an improved method of removing adherent biofilm from solid surfaces that does not corrode, erode, abrade or otherwise harm such surfaces.

Yet another object of the invention is to provide a method that employs a simple system and composition for removing biofilm from surfaces.

An additional object of the invention is to provide an improved method of removing biofilm from solid surfaces that thoroughly removes biofilm matrix material as well as microorganisms.

Yet another object of the invention is to provide an improved method of removing biofilm from solid surfaces that does not require the use of potentially toxic or corrosive chemical agents such as biocides.

Still another object of the invention is to provide an improved method of removing biofilm from solid surfaces that can be used to remove biofilms from the interior surfaces of conduits, such as conduits used in clinical dental water systems, or in food and pharmaceutical manufacturing operations.

Another object of the invention is to provide a simple composition comprising water and a single non-toxic, non-corrosive ingredient that will thoroughly remove biofilm from surfaces without harming the surfaces when used in combination with the method or apparatus disclosed herein.

A further object of the invention is to provide improved apparatus for removing biofilm from solid surfaces.

An additional object of the invention is to provide improved apparatus for removing biofilm from solid surfaces that does not corrode, erode, abrade or otherwise harm the surface.

Another object of the invention is to provide improved apparatus for removing biofilm from solid surfaces that thoroughly removes biofilm matrix material..

Yet another object of the invention is to provide improved apparatus for removing biofilm from solid surfaces without using potentially toxic or corrosive chemical agents such as biocides.

A further object of the invention is to provide improved apparatus for removing biofilm from solid surfaces that can be used to remove biofilms from the interior surfaces of conduits, such as conduits used in clinical dental water systems, or in food and pharmaceutical manufacturing operations.

### NUMERICAL IDENTIFICATION OF COMPONENTS ON DRAWING FIGURES

10 suspension of particles in fluid

12 container

14 magnetic stirring bar

16 magnetic stirrer drive unit

18 pump

20 feed conduit

22 coupling

24 filter

26 three-way valve

28 conduit to be cleaned

30 supply of pressurized liquid, e.g., water

32 fittings

34 drain valve

36 tee

38 pump-around return conduit

40 valve, e.g., a globe valve

42 flexible membrane

44 slurry compartment

46 forcing fluid compartment

### DESCRIPTION OF THE INVENTION

According to the present invention, a suspension of solid particles (sometimes called a slurry) suspended in a fluid is caused to flow in contact with a solid surface in order to remove adherent biofilm from the surface. According to the present invention, flow of a particle suspension is not directed normal (i.e., not at an angle of ninety degrees) to the surface. Rather the flow is directed at an angle lying between normal and parallel to the surface to be cleaned of biofilm, in order to eliminate or greatly minimize head-on collisions between the particles and the surface. Such head-on collisions are disadvantageous for two reasons: (1) head-on collisions transfer maximum particle momentum to the surface causing forceful impacts that have the greatest chance of damaging the surface and, (2) head-on collisions can impact biofilm into small crevices or imperfections in the surface, thereby making the biofilm more difficult to remove.

In an embodiment of the present invention, a particle suspension is caused to flow parallel to the surface (as in the case of flow of suspension inside a conduit wherein the flow direction is parallel to the inner wall of the conduit). Surprisingly, such parallel flow has been found to be effective in removing biofilm from the inside surface of conduits, as indicated by the experimental results in the Examples below. These results are surprising because the parallel flow path suggests that the suspended particles moving with the flowing liquid make only glancing impacts with the wall of the conduit. Merely glancing impacts are expected to be ineffective for removing biofilm in that they transfer only small amounts of momentum to the biofilm. The Examples below demonstrate that such parallel flow of suspension along a surface, which is expected to impart negligible damaging impact to the surface, is very effective for removing biofilm from the surface. The experimental results of the Examples support the conclusion that grazing impacts of the particles with the biofilm are very effective in removing the biofilm from the surface.

Often the suspension employed in the instant invention will be one of solid particles in water or other liquid; such a suspension in a liquid is often called a slurry. According to the invention, the flow of suspension is directed against or along a surface on which biofilm is deposited and from which it is intended to remove biofilm. The combined action of the moving fluid and particles removes the biofilm, including microorganisms and biofilm matrix in which microorganisms are embedded. The biofilm so removed becomes suspended in the fluid. As disclosed in the Examples below, the inventive removal of biofilm from a conduit surface by flowing suspension according to the invention is extremely thorough. Other methods of removing biofilm from surfaces have been reported to be incapable of thoroughly removing the matrix, as discussed above under background art for removing biofilms.

Many multiple-component compositions have been previously disclosed for removing biofilm from surfaces (as discussed above under background art for biofilm removal). In view of the previous and widespread use of such complex, multiple-component compositions, it is surprising and advantageous that, according to the present invention, use of a suspension consisting essentially of a single ingredient (solid particles) added to a fluid such as water suffices to thoroughly remove biofilm from surfaces. The thoroughness of removal according to the instant invention has been carefully investigated by scanning electron microscopy (SEM) as disclosed in the Examples below.

When the flow of suspension in contact with the surface to be cleaned is directed against the surface at larger angles that approach (but do not attain) a direction normal to the surface, smaller flow velocities are preferred to protect the surface from damage. By comparison, in situations in which the angle is smaller, larger velocities can be used while avoiding surface damage. When the fluid flow is largely parallel to the surface, larger velocities are required to impel the particles against the surface with sufficient force to remove biofilm effectively therefrom. In order to avoid damage to the underlying solid surface by the particles, it is preferred to use smaller fluid velocities when the flow direction is close to normal to the surface, and greater velocities as the flow direction approaches an angle parallel to the surface from which biofilm is to be removed.

When the effective direction of flow of suspension is parallel to the surface, such as for flow of a fluid suspension in a tube or similar cylindrical conduit, it would be expected that the particles move parallel to the tube wall. Particles, which move parallel to the wall surface, would be expected to have very little effect on the solid surface, or on a biofilm deposited upon the surface. Surprisingly, however, we have discovered that biofilm is indeed effectively and thoroughly removed by particle suspensions in water flowing in tubes. In contrast, however, far less biofilm is removed by only water flowing at the same velocity through a tube, or by a biocidal, aqueous hypochlorite solution flowing at the same velocity through the tube. In experiments employing turbulent flow conditions and disclosed in the Examples below, slurries consisting essentially of particles in water effectively removed biofilm from the interior walls of cylindrical tubes. Control experiments, which were otherwise identical except that particles were not employed, were far less effective in removing biofilm. We hypothesize that random motion of turbulent eddies in the fluid transfer some momentum to the particles. Such transferred momentum is believed to cause the particles to move to the tube wall, penetrate the fluid boundary layer at the wall and impinge grazingly upon the biofilm on the wall of the tube, thereby dislodging biofilm. We do not suggest or intend, however, that any hypothesis should limit the invention in any way.

Generally, for flow of Newtonian fluids such as water in tubes, the nature of the flow can be characterized by a dimensionless quantity called Reynold's number (Re), which can be computed from the formula:

Re=DVρ/μ

where D is inner diameter of the tube, V the mean linear velocity of the fluid, ρ the fluid density and μ the viscosity of the fluid, all in consistent units; V can be computed by dividing the volumetric flow rate by the cross sectional area of the tube. Generally, the nature of flow is laminar when Re values are below about 2000 and fully turbulent when values of Re are above about 4000. In the range of Re values between 2000 and 4000, the flow can be either laminar or turbulent and can fluctuate over time between laminar and turbulent. Although a wide range of Reynold's numbers can be employed, in a preferred embodiment of the present invention, slurries of particles flow in a conduit under conditions such that the Reynold's number is greater than about 100, with Reynold's numbers of 2000 or greater being especially preferred.

Although a wide range of flow velocities can be employed, in a preferred embodiment of the present invention, flow of suspension in conduits should be near or above the critical velocity, the value of which can be determined by experiment. The critical velocity is defined as the minimum velocity of flow of a suspension at which the solid particles do not deposit to form a bed on the bottom wall of a horizontal conduit. Although laminar flow is not excluded from use in the invention, it is also preferred that the fluid flow condition be turbulent, or nearly so when using a flowing slurry of particles in liquid to remove biofilm from the inside wall of pipes, tubing and similar conduit.

For suspensions of particles in liquid, the critical velocity is typically between one and five meters/second. Critical velocity is influenced by the relative densities of solid and liquid, the particle diameter, the slurry concentration and the dimensions of the conduit, according to McCabe Smith and Harriott in “Unit Operations of Chemical Engineering”, fourth edition, McGraw-Hill 1985. Oroskar and Turian [(AIChE Journal, volume 26, pp. 550-558 (1980)] give a semi-theoretical correlation for predicting the critical velocity for flow of slurries. The critical velocity for flow of suspensions of particles in gases can be estimated from an empirical equation given in “Unit Operations of Chemical Engineering” by McCabe, Smith and Harriott, p. 157, fourth edition, McGraw-Hill 1985. For flow of particles in gases the critical velocity depends significantly on particle size and is typically in the range of about ten to thirty meters/second. Predictive equations for critical velocity are only approximate and cannot be relied upon with precision but critical velocity can be determined by experimental observation as stated above. In practice, flow of particle suspensions is usually conducted at flow rates exceeding the critical velocity, and up to several times the critical velocity.

Although any shape of particle can be used, it is preferred that the particles used in the present invention be angular to better engage the biofilm and sufficiently soft that they do not damage the underlying surface on which the biofilm is deposited. Also, particles having a wide range of size can be employed. Generally the size range of the particles should be from about a nanometer to about a few millimeters, depending on conduit size, fluid flow rate, fluid density and viscosity, particle density and concentration of the suspension. The most favorable size of particle will depend strongly on the relative specific gravities of the fluid and of the particles, and on the velocity at which the suspension is directed at or along the surface to be cleaned. As shown in the Examples below, acrylic resin particles of size less than about 0.1 mm suspended in water form a slurry that is very effective for removing biofilm from the walls of polyurethane DUWL tubing. This behavior, was observed in experiments described in the Examples below, wherein the flow through the tubing is in the turbulent regime, as indicated by the Reynolds number computed based on tubing diameter and fluid velocity, viscosity and density. Although a wide range of concentrations can be employed, a preferred concentration range of the particles in suspension is about 0.01 to about 20% (by weight), with about 0.1 to 8% being especially preferred. Good results have been obtained, as set out in the Examples below, using 1% and 2% (percent by weight) acrylic particles suspended in water.

Generally particle and fluid properties should be such that the particles remain in suspension while the suspension flows at the velocity employed, e.g., the specific gravity of the particles should be near that of the fluid to discourage settling of the particles from the suspension. Generally, the flow velocity employed should be sufficiently large to cause turbulent flow, provided the turbulence properties do not damage the surface. Generally, water is a favorable fluid for use in the suspension based on cost, toxicity and safety, but the use of other liquids and gases is not excluded.

Some typical materials that are available in appropriate sizes, and that can be used for the particles in the slurries employed in the present invention, are listed in the following table:

| Material | Hardness (MOH) | Specific Gravity |
|---|---|---|
| Acrylic resin | 3.2-3.5 | 1.1-1.2 |
| ADGC resin | 2.5-3.0 (estimated) | 1.3-1.32 |
| UF resin | 3.5 | 1.47-1.52 |
| Calcite (calcium carbonate) | 3 | 2.7 |
| Gibbsite (alum. ox. hydr.) | 2.5-3.0 | 2.4 |
| Quartz | 7 | 2.65 |
| Talc (Mg silicate) | 1 | 2.6-2.8 |
| Silicon carbide | 9.5 | 3.2 |
| Gypsum (calcium sulfate) | 2 | 2.3 |
| Powdered activated carbon | Depends on | 2 or less |
| | mineral content | |
| Corundum (alum. oxide) | 9 | 4.0 |
| Sodium bicarbonate | 2.4-3.0 | 2.2 |

In the foregoing table, UF stands for urea-formaldehyde and ADGC for allyldiglycolcarbonate. Specific gravity values given in the table above are relative to water so that the numerical value of specific gravity of a material is about equal to the density of the material expressed in grams per cubic centimeter. Although particles of a wide range of hardness can be used, generally, it is also preferred that the particles employed be of materials softer than the surface to be cleaned, in order to avoid possible damage to the surface from which biofilm is to be removed.

Although particles having a wide range of specific gravity can be employed, for a suspension used in the instant invention, it is preferred that the specific gravity of the particles be close to that of the liquid in which they are suspended in order to facilitate maintaining the particles in the suspended state. Although particles and fluids having a wide range of density can be used, it is generally preferred that the density of the particles be in the range of about 0.2 to 20 grams per cubic centimeter, 0.5 to 4.0 grams per cubic centimeter being especially preferred. It is also preferred that the ratio of particle density to fluid density be in the range of about 0.3 to 3, with a range of about 0.5 to 2.5 being especially preferred. For use with water to form suspensions, materials with specific gravities near one are preferred, such as the first three materials listed in the table above. Sodium bicarbonate also appears especially attractive for use in in the present invention based on its relatively low hardness and density, as well as because it is widely used as an ingredient in foods and pharmaceuticals. Sodium bicarbonate, listed as GRAS by the FDA, is a mild abrasive that is used by dentists to clean teeth and by electronic parts manufacturers to polish and clean sensitive parts. In particular, sodium bicarbonate has the additional advantage of eventually dissolving in water after sufficient dilution of its saturated aqueous suspensions, such suspensions being a preferred form in which a partially soluble material would be used to remove biofilm from surfaces. Sodium bicarbonate is also relatively benign from the standpoint of toxicity and environmental effects.

In some embodiments, after removing biofilm from a surface according to the invention, it is desirable to separate the solid particles from the biofilm and collect the particles so they can be re-used, or disposed of separately from the biofilm. If the solid particles are denser than the fluid and the biofilm, separation of the particles can be accomplished by permitting the mixture of biofilm and suspension (solid particles and fluid) to settle under the influence of gravity. This can be accomplished by conducting the mixture into a suitable vessel or container where gravity settling can occur and the resulting supernatant mixture of fluid and biofilm suspended therein can be drawn off from the settled solid particles.

Although it is generally preferred that the suspended particles used in the instant invention be softer than the surface to be cleaned in order to avoid damaging or abrading the surface, harder particles can also be employed. For example, harder particles may be more effective for removing hard, mineralized biofilm. Generally, older biofilm can become significantly hardened by mineralization because the speed of mineralization is usually slow compared to the rate of formation of fresh biofilm. Accordingly, it is also contemplated under the instant invention to employ a suspension of hard particles, especially when a hard (as may arise from mineralization) biofilm must be removed. In such cases, it may be desirable to employ particles harder than the underlying surface on which the biofilm has formed. After a hard, mineralized biofilm has been removed using a suspension of hard particles, a suspension of softer particles may then be subsequently employed to rid the suface of fresh, soft biofilm that newly re-forms on the surface.

According to the instant invention, cleaning of biofilm is carried out by forming or providing a suspension of particles in a fluid and causing the suspension to flow in contact with (against or along) a surface on which the biofilm adheres. Usually the suspension is provided in a container or reservoir and set in flowing motion by a pump, or by gravity induced flow. A wide variety of pump types can be employed, including peristaltic, centrifugal, piston, lobe and gear pumps. It is desirable to provide means of agitating the slurry to keep the particles in suspension, e.g., by mixing using a stirrer, or by sparging the suspension using air bubbles, or by agitating or vibrating or shaking the container. If the particles and the fluid in which they are suspended are of equal or nearly equal density, or if the particles are sufficiently small that they remain in suspension by action of Brownian motion, then agitation may not need to be employed to maintain a uniform suspension of particles.

The preferred duration of cleaning according to the present invention will depend among other things on the thickness and other properties of the biofilm, as well as on the desired extent of biofilm removal from the surface to be cleaned. For the biofilm employed in the Examples below that was formed over only a seven day period, treatment with slurry for only a fraction of a minute was sufficient to obtain a significant reduction of biofilm, as measured by a chemiluminescent assay of peroxidase activity of the biofilm. For biofilms that have formed and accumulated over longer periods of time, longer cleaning times may be required, for example up to about an hour for thick, hard biofilm. The actual cleaning time should be chosen with consideration of the extent of biofilm removal that is desired, the hardness of the biofilm, the hardness of the suspended particles and the extent of wear that can be tolerated on the surface to be cleaned. Although a wide range of cleaning times can be used when practicing the instant invention, generally, preferred cleaning times will be in the range of about three seconds to about thirty minutes.

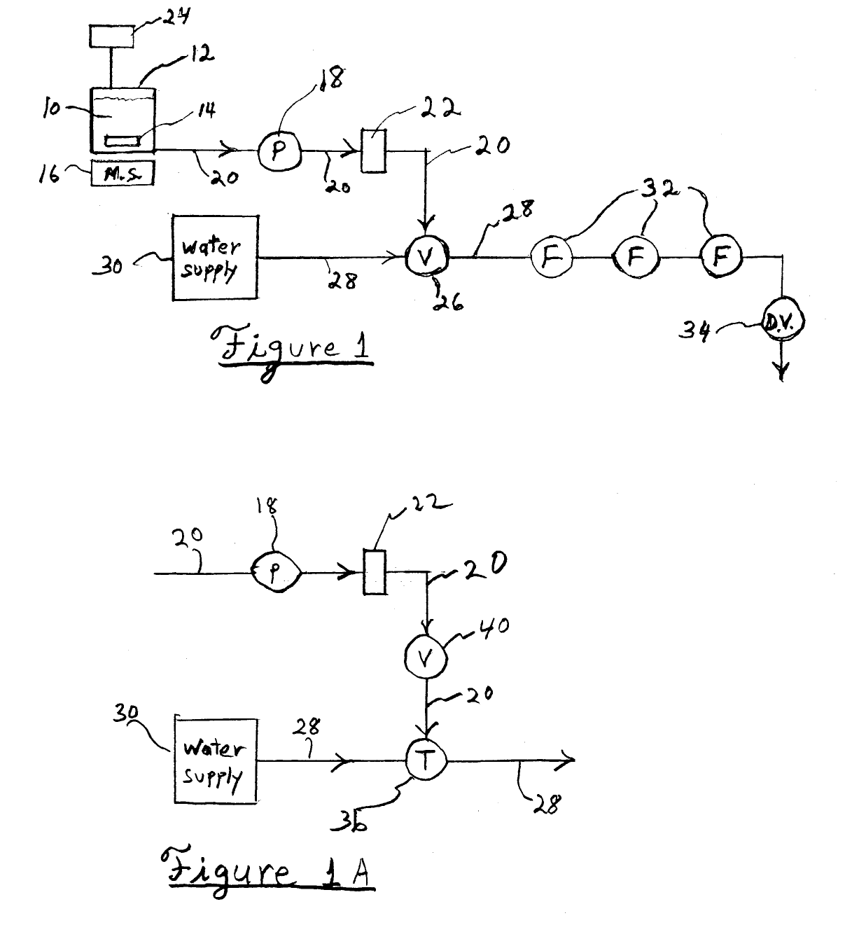

The invention can be more fully understood by reference to the schematic diagram shown in FIG. 1. Referring to FIG. 1, a liquid slurry or suspension 10 of particles held within container 12 is agitated by magnetic stirring bar 14 driven by magnetic stirrer 16. The particle suspension 10 is pumped from container 12 by peristaltic pump 18 through feed conduit 20 to coupling 22 which is of the quick connect/disconnect type. As liquid suspension 10 is pumped out of container 12, ambient air enters container 12 through filter 24 .

Suspension is pumped through coupling 22 and 3-way valve 26 into conduit 28, which is coated with undesired biofilm on its inner wall. Three-way valve 26 permits the conduit 28 to be isolated from a pressurized water supply 30 (e.g., a municipal water supply) while suspension is pumped through conduit 28. In addition to valve 26, conduit 28 includes various fittings 32 such as those labeled F in FIG. 1 and also connects to drain valve 34 labeled DV in FIG. 1. The fittings 32 can be elbows, bushings, tees, valves, constrictions, couplings and the like. As the suspension is pumped through conduit 28 and fittings 32, it removes biofilm (not shown in FIG. 1) from the inner, wall surface of conduit 28 and its associated fittings 32. Biofilm fragments so removed enter the flowing suspension and pass from the system with the suspension through open drain valve 34. The mixture emerging from drain valve 34 can be conducted into a container (not shown) that contains a biocide that kills or inactivates microorganisms removed from the wall of conduit 28 and its associated fittings 32 into the suspension. Alternatively, biocide can be added directly to suspension 10 in container 12 in order to inactivate microorganisms in the particles of biofilm removed from the walls of conduit 28 and fittings 32. The mixture emerging from drain valve 34 can be conducted into a settling vessel or tank where solid particles are allowed to settle under the influence of gravity and the supernatant mixture of fluid and biofilm is drawn off to separate it from the solid particles. The solid particles can then be re-used or disposed of separately from the mixture of fluid and biofilm.

The apparatus of FIG. 1 is operated by stirring a slurry or suspension 10 in container 12 while pumping the suspension through coupling 22 into conduit 28 which is intended to be cleaned of biofilm. Three-way valve 26 permits switching from the normal water supply 30 to the cleaning suspension 10 for biofilm removal from conduit 28.

It is possible to adapt the apparatus of FIG. 1 to inject a slurry of particles into another liquid flowing through conduit 28, as shown in FIG. 1A. In such an embodiment, tee 36 in FIG. 1A replaces three-way valve 26 of FIG. 1. Further, as shown in FIG. 1A, valve 40, located in the conduit between tee 36 and coupling 22, regulates the flow of slurry entering tee 36 from pump 18 through coupling 22. In the embodiment of FIG. 1A, suspension is pumped through valve 40 and tee 36 into liquid flowing from liquid supply 30 into conduit 28. In this embodiment, the concentration of the injected slurry flowing through tee 36 is chosen to provide a particle concentration in the liquid flowing through conduit 28 that is effective for removing biofilm from the inner wall of conduit 28. In this way biofilm cleaning can be accomplished without the need for a three-way valve to isolate liquid supply 30 from the conduit to be cleaned.

Agitation of the suspension 10 can also be accomplished by other means such as shaking, bubbling air through it, or by pumping a portion out of container 12 and back into the container using a tee 36 and pump-around return tubing 38, as shown in FIG. 2. In FIG. 2, valve 40 regulates the flow of suspension back to container 12 and to coupling 22 that connects the flow of suspension to a conduit 28 containing fittings 32 and drain valve 34, in a manner similar to the arrangement shown in FIG. 1. The apparatus of FIG. 2 is operated similarly to that of FIG. 1, except that the pump-around return conduit 38 provides mixing to maintain the particles suspended in the fluid within container 12.

When the suspended particles are water soluble (e.g., sodium bicarbonate), then it is desirable that the suspension 10 in FIGS. 1 and 2 comprise a saturated or nearly saturated aqueous solution of the particulate material (e.g., sodium bicarbonate). When such a suspension is mixed with additional water upon flowing from conduit 20 into conduit 28, additional particulate material will tend to dissolve. Thus it is desirable that the ratio of flow rate in conduit 20 to that in conduit 28 be sufficiently large that a substantial portion of the particles do not dissolve in the conduit 28. Such dissolution can also be avoided by keeping the residence time of the particles in conduit 28 (and associated fittings 32 or 34) sufficiently small that a substantial portion of the particles remain undissolved during their passage through conduit 28 and other parts of a system intended to be cleaned.

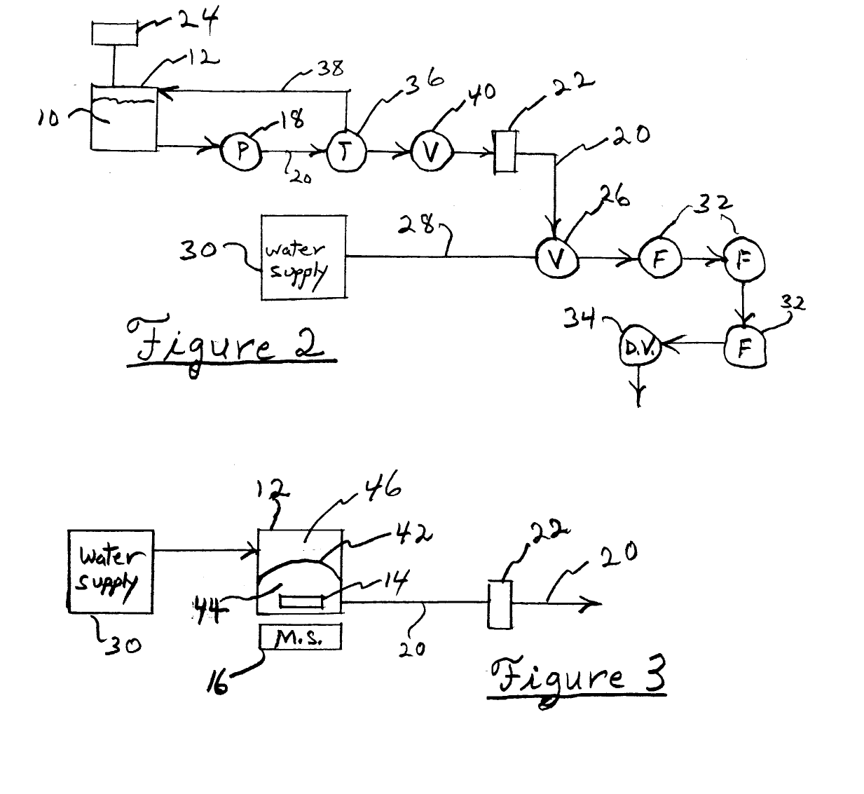

Pumping of slurry can also be accomplished by means other than a typical pump, such as by using gravity-induced flow, or by using a pressurized water supply 30 as a forcing fluid to pressurize a flexible membrane 42 in contact with the slurry as shown in FIG. 3. In FIG. 3, forcing fluid in the form of a pressurized water supply 30 (e.g., a municipal water supply, a pressurized gas could also be used) enters forcing fluid compartment 46 in the upper part of container 12. The forcing fluid presses against a flexible membrane 42, which separates container 12 into two inner compartments: a slurry compartment 44 and a forcing fluid compartment 46. Membrane 42 is in contact with slurry held within slurry compartment 44, thereby impelling the slurry through tubing 20 and coupling 32 to a biofilm-coated conduit (not shown in FIG. 3) which is similar to conduit 28 shown in FIG. 1. A stirring bar 14 and a magnetic stirrer 16 are also depicted in FIG. 3 and they serve the purpose of agitating the slurry, in a manner similar to that for the apparatus shown in FIG. 1.

The apparatus of FIG. 3 is operated similarly to that of FIG. 1 except that a supply of pressurized fluid (e.g., water) 30, in combination with membrane 42 is used as a pumping means to propel suspension 10 into conduit 28 to be cleaned of biofilm.

In FIGS. 1, 2 or 3 conduit 28 and associated fittings 32 can be (for example) water lines and fittings in clinical dental units, process flow lines and associated fittings in plants that manufacture drinking water, pharmaceuticals, vitamins, food or any other substances that require clean conditions.

The surface of an article to be cleaned according to the present invention need not be the wall of a conduit. It can be any surface on which biofilm can form. For example, the apparatus of FIGS. 1, 2 or 3 can be adapted and employed to direct a flow of particle suspension 10 along or against a biofilm-coated surface (at an angle less than normal to the surface) of any article or object (e.g., a medical catheter or endoscope) intended to be cleaned. In such instances, coupling 32 can be replaced by a nozzle to form a jet of flowing suspension that is directed at or along the surface to be cleaned. The jet directs the suspension at or along any surface that is substituted for the wall of conduit 28 in the Figures. In this embodiment of the invention, the suspension is supplied by the portion of the apparatus to the left of coupling 32 in FIGS. 1, 2 and 3; coupling 32 is replaced by a nozzle that directs the flow of suspension toward a surface of an object to be cleaned; the portion of the apparatus to the right of the coupling is replaced by the article to be cleaned.

In another embodiment of the present invention, biocide is added to the suspension before, during or after biofilm removal in order to kill and prevent growth of microorganisms in the biofilm fragments removed from a surface according to the invention.

### EXAMPLES

The following examples demonstrate the invention, its operation and its superior properties. These examples are illustrative only and hould not be construed as limiting the scope or breadth of the invention in any way.

The biofilm-removal experiments described in the Examples below were conducted at room temperature with aqueous slurries or solutions flowing at a volumetric flow rate of 450 ml/min (0.075 m³/sec) through tubing of 1.5 mm (1.5×10⁻³ m) inside diameter. For these experiments, the mean linear velocity V in the tubing (computed as volumetric flow rate divided by cross sectional area of the tubing) was 4.25 m/sec. For these experiments, the Reynold's number, Re, was computed to be 6369 using the formula given above and the following properties of water: density (ρ)=1000 kg/m³ and viscosity (μ)=0.001 kg/(m-sec). The Examples below and these experimental values are intended to be illustrative only and are not intended to limit the invention in any way.

### Example 1

### Preparation of Bacterial Cultures

Sterile Difco Tripticase Soy Broth (TSB) (50 ml) was inoculated with Pseudomonas aeruginosa (ATCC 700829) (this bacterium is sometimes referred to herein as PA) using cells scraped from a frozen culture using sterile Pt loop. The TSB had been prepared with sterilized 18 megohm pure water. This starter culture was incubated in a 250 ml-flask at 30° C. for 24 hr with shaking at 150 rpm. To prepare the culture employed to form biofilm on tubing walls, the 24-hr starter culture was added to 100 ml of (tenth strength) sterile TBS in a 250-ml flask until an OD of 0.1 was attained. This occurred after about 10 ml of 24-hr starter culture was added to the dilute sterile TSB.

### Example 2

### Formation of Biofilm Inside Tubing

Biofilm-forming culture (100 ml prepared as described in Example 1) was re-circulated by a peristaltic pump from a reservoir through three, 18.75-inch lengths (designated I, II or III) of tubing in parallel, and returned to the reservoir. Three pump heads were used and the flow rate through each length of tubing was 150 ml/hr. The tubing [about 3 mm in outside diameter (o.d.) and about 1.5 mm in inside diameter (i.d.)] was clear polyurethane Durometer 90A obtained from A-dec, Inc. Newberg, Ore. This tubing is typically used as conduit for water in dental units (dental unit water lines, sometimes referred to as DUWLs). The reservoir was a 250-ml flask, which was continuously stirred magnetically and aerated by sparging with sterile-filtered air. Biofilm became established on the inner wall of the tubing by operating this apparatus at room temperature, under ambient lighting for seven days.

### Example 3

### Preparation of Biofilm-Coated Tubing (BFCT) for Further Investigation

Each tubing length (designated Length I, Length II or Length III) of BFCT was removed from the re-circulation apparatus described in Example 2 and placed in a sterile petri dish. Working in a filtered laminar flow hood (Biosafety Level II), each BFCT Length was cut into four upstream segments (each 3.75 in long and designated A, B, C, D) for investigation of cleaning protocols using liquid suspensions of particles according to the present invention. Biofilm was assayed by a chemiluminescent method described more fully in subsequent examples. A fifth downstream segment (3.75 inches long) designated E was removed only from tubing length II for investigation of cleaning by a slurry protocol according to the present invention, and employing scanning electron microscopy (SEM) to assess the status of the biofilm before and after cleaning. Segment II-E was not used in experiments employing chemiluminescent measurements. Excess tubing (i.e., other than those segments mentioned) was not investigated further.

Each 3.75-inch BFCT segment was stored in a dedicated sterile petri dish. Each BFCT segment was cut into three 1.25-inch long sub-segments (designated 1, 2,or 3), which were maintained in each of the respective petri dishes. Herein each sub-segment is identified by a Roman numeral (three original, 18.75-inch tubing lengths are referred to as I, II and III), Roman letter (each 3.75-inch long segment of a tube is referred to as A, B, C and D) and Arabic numeral (each 1.25 inch long sub-segment of a segment is referred to as 1, 2 and 3). Pieces from segments A, B, C, D, were rinsed with sterile water as described in the next paragraph.

Each 3.75-inch segment, designated as A,B,C,D (and E only for tubing length II), was re-assembled from its three sub-segments in their original sequential order by inserting sterile male-to-male Luer connectors (BioRad catalogue #7318230) between sub-segments. After re-assembly, each segment was rinsed by a gentle flow (2.5 ml/min for 2 minutes) of sterilized, 18 megohm pure water dispensed by a syringe pump. After rinsing, excess water was removed from each segment while it was held in a vertical orientation by applying sterile blotting paper to its lower end. Each rinsed segment was stored in its own petri dish.

### Example 4

### Assaying Biofilm in BFCT Segments A, B, C, D Using Chemiluminescent Method

The biofilm present in each rinsed sub-segment of segments A, B, C, and D from Example 3 was assayed by measuring its hydrogen peroxidase activity using a chemiluminescent method. Briefly, reagent solution was injected into each pre-rinsed sub-segment by a pipette, the sub-segment was inserted in the pipette adapter port of a Turner Designs Model 20E luminometer. Further experimental details are given in Example 5 below. The measurements of established biofilm in the tubing are discussed below in comparison with biofilm assays made after subjecting the tubing to different cleaning protocols. After chemiluminescent assay of the biofilm, assay reagent was removed from each sub-segment by contacting a tip of each sub-segment with blotting paper. Each segment was again re-assembled from its sub-segments in original sequential order. The segments comprising re-assembled segments were next subjected to sanitizing protocols using water, standard hypochlorite solution or the novel protocol, which employs a slurry of particles according to the present invention.

### Example 5

### Chemniluminescent Assay Protocol

Reagent Solutions

A 100 mM Tris buffer solution was prepared (pH 8.0). A 3% hydrogen peroxide solution was prepared from 30% H₂O₂ solution (Sigma). A stock solution of Luminol (5-amino-2,3-dihydro-1,4-phathalazinedione ( also known as 3-aminophthalhydrazide) was prepared by dissolving 10 mg of Luminol (Sigma Chemical) in 1 ml of DMSO. This solution is stable for at least one month if stored refrigerated. Working Chemiluminescent Reagent was prepared by dissolving 15 ul of stock Luminol solution in 2 ml of 100 mM Tris buffer, pH 8.0 (by vortexing to ensure that the Luminol dissolves in the aqueous buffer) and adding 5 microliters of 3% H₂O₂ solution thereto. The resulting working reagent is stable for only about one day. It was freshly prepared daily and kept on ice during the day it is used.

Assay Procedure

A Turner Designs, Model 20e Luminometer was employed in regular ATP operating mode, auto range on, full integral output, and signal time of 10 sec. Fifty microliters of working chemiluminescent reagent was drawn into a pipette tip (size 1-200 microliters) and a sub-segment of tubing was attached to the filled pipette tip. The pipette (with the attached sub-segment of tubing) and its holder was placed on the pipette adapter of the luminometer. The start switch of the reagent injector system was switched on by depressing the pipette actuator and holding it during the measurement cycle. After measurement, the intensity of the light from the luminescent reaction was displayed as a four-digit number proceeded by an “F” and the number was printed. After measurement, the pipette actuator was released and the sub-segment of tubing was detached from the pipette.

Calibration of Chemiluminescent Assay

Using a log-phase, 24-hr culture of PA, serial dilutions were spread on TSA plates and colonies were counted. They were also subjected to the chemiluminescent assay protocol. The results are presented in the table below. It is evident that a near linear relationship was found between chemiluminescence measurement of peroxidase activity and the concentration of PA bacteria in the planktonic culture suspension.

Chemiluminescence Assay of Peroxidase Activity
of Pseudomonas aeruginosa Cells in Suspension

| | | Chemiluminescence (Turner Units) | | | | |
|---|---|---|---|---|---|---|
| | | Colony Forming Units per 5 μL | | | | |
| Replicate | Water | 7.50 × | 3.70 × | 1.85 × | 0.93 × | 0.46 × |
| Number | Blank | 10⁵ | 10⁵ | 10⁵ | 10⁵ | 10⁵ |
| 1 | 2.2 | 30.0 | 11.9 | 5.1 | 2.8 | 2.1 |
| 2 | 1.7 | 26.7 | 11.1 | 5.1 | 3.1 | 2.1 |
| 3 | 1.6 | 25.0 | 12.2 | 5.3 | 2.6 | 2.2 |
| Average | 1.8 | 27.2 | 11.8 | 5.2 | 2.8 | 2.1 |
| (n = 3) | | | | | | |
| Ave-Blank | 0 | 25.4 | 9.9 | 3.3 | 1.0 | .3 |
| Std dev | 0.3 | 2.5 | 0.6 | 0.1 | 0.2 | 0.1 |
| C.V. (%) | 16.7 | 9.2 | 5.1 | 1.9 | 7.1 | 4.8 |

The data in the table above can be fit to a straight regression line of the formula: y = 3.64x − 2.53 where y is mean chemiluminescence (average-blank) and x is CFU/100,000. The regression coefficient is R² = 0.99

### Example 6

### Removal of Biofilm by Flowing Water (Control) and by Particle Suspensions (Slurries) According to the Present Invention

Three different washing preparation compositions were used to remove biofilm:

Sterilized, 18-megohm pure water

Sterilized 18-megohm pure water containing suspended acrylic particles (1% w/w)

Sterilized 18-megohm pure water containing suspended acrylic particles (2% w/w)

Acrylic particles (specific gravity=1.1-1.2; hardness 3.4-3.5 moh) were obtained from a nearby vendor. They were sieved and only sizes less than about 0.1 mm were used. The particles were maintained in suspension by stirring a reservoir of the suspension. In order to clean DUWL tubing, sterile water or suspension was pumped through each segment at a flow rate of 450 ml/min. The experiments are summarized as follows:

Tubing Length I segments A,B,C,D cleaned by flowing sterile water

Tubing Length II segments A,B,C,D cleaned by flowing 1% suspension

Tubing Length III segments A,B,C,D cleaned by flowing 2% suspension

Segments designated A were cleaned for 0.25 min, those designated B for 0.5 min, those designated C for 1.0 min and those designated D for 3.0 min.

### Example 7

### Chemiluminescent Assay of Biofilm on Inner Wall of Tubing Before Cleaning and Remaining After Different Cleaning Protocols.

The biofilm in each sub-segment of segments A,B,C,D that had been treated [by flowing water (Length I) or by flowing suspensions (Lengths II and III)] was rinsed with purified, sterile water using a syringe pump as described in Example 3 above and then assayed for peroxidase activity as described in Example 5 above. The results are summarized below in Table 1, which contains the assay measurements before and after cleaning.

TABLE 1
Measured peroxidase activity in tubing sub-
segments, Turner chemiluminescence units.

| | LENGTH I | | LENGTH II | | LENGTH III | |
|---|---|---|---|---|---|---|
| | | After | | After | | After |
| Sub- | Before | Cleaning | Before | Cleaning | Before | Cleaning |
| Segment | Cleaning | by water | Cleaning | by 2% sl. | Cleaning | by 1% sl. |
| A1 | 29.7 | 26.7 | 33.8 | 2.0 | 36 | 5.5 |
| A2 | 21.7 | 18.6 | 45.3 | 0.8 | 23.5 | 1.6 |
| A3 | 21.2 | 21.2 | 36.8 | 1.4 | 30.7 | 1.3 |
| B1 | 14.5 | 12.9 | 14.4 | 0 | 49.1 | 5.0 |
| B2 | 17.3 | 16 | 12.9 | 0 | 24 | 0.5 |
| B3 | 12.4 | 8.2 | 18.7 | 0.7 | 22.4 | 0.7 |
| C1 | 34.1 | 30.8 | 16.6 | 0.6 | 22.7 | 0.4 |
| C2 | 19.7 | 12 | 18.7 | 0.2 | 24.5 | 0.7 |
| C3 | 17.5 | 12.4 | 20.8 | 0.8 | 16.5 | 0.6 |
| D1 | 24 | 20.1 | 20.7 | 0 | 35.7 | 0.5 |
| D2 | 18.9 | 9.6 | 30.5 | 0 | 18.3 | 0.4 |
| D3 | 12.5 | 6.7 | 11.1 | 0 | 20.3 | 1.0 |
| MEAN | 20.3 | 16.3 | 23.4 | 0.54 | 27 | 1.5 |
| STD DEV | 6.5 | 7.4 | 10.7 | 0.42 | 9.3 | 1.7 |
| C.I. | 4.2 | 4.7 | 6.8 | 0.41 | 5.9 | 1.1 |

A segment—cleaned 0.25 min
B segment—cleaned 0.5 min
C segment—cleaned 1 min
D segment—cleaned 3 min
C.I.—confidence interval
(95%)
STD DEV—standard deviation

It is evident from Table 1 that treatment with the slurry suspensions removes significantly more (greater than 90%) of peroxidase activity. Cleaning treatment with only water removed only about 20% of the peroxidase activity of the biofilm. These results are substantiated by SEM investigation of sub-segments of segment II-E as reported in subsequent Examples 9, 10 and 11 below.

### Example 8

### Testing Possible Re-Growth of Biofilm on Tubing After Cleaning by Flowing Water and Suspensions

Sterile, autoclaved tap water was pumped (150 ml/hr for three days) through each cleaned segment and the sub-segments were again assayed for peroxidase activity in order to determine the extent of biofilm re-growth on the cleaned segments. Chemiluminescent measurements of re-grown biofilm are summarized in Table 2 below. It is evident that significant re-growth occurred in the tubing segments (from Length I) cleaned by sterile water alone, whereas those tubing segments (from Lengths II, III) treated by the slurries gave evidence of essentially no re-growth, based on the chemiluminescent assay measurements of peroxidase. As discussed in Example 12 below, SEM investigation of sub-segments confirmed that there was no visible regrowth on tubing that had been cleaned by the slurry treatment.

TABLE 2
Measured peroxidase activity after biofilm
regrowth, Turner chemiluminescence units.

| | | LENGTH I | | |
|---|---|---|---|---|
| Sub- | Cleaning | Sterile | LENGTH II | LENGTH III |
| Segment | Time (min.) | Water | 2% Slurry | 1% Slurry |
| A1 | .25 | 28.9 | 2.1 | 1.4 |
| A2 | .25 | 30.3 | 1.7 | 1.3 |
| A3 | .25 | 26.0 | 1.2 | 0.9 |
| B1 | .50 | 30.8 | 0.1 | 5.2 |
| B2 | .50 | 17.4 | 0.1 | 2.3 |
| B3 | .50 | 9.6 | 2.7 | 3.1 |
| C1 | 1.0 | 36.2 | 0.7 | 2.2 |
| C2 | 1.0 | 12.6 | 0.4 | 1.1 |
| C3 | 1.0 | 14.7 | 0.5 | 0.9 |
| D1 | 3.0 | 23.5 | 0.8 | 0.6 |
| D2 | 3.0 | 14.0 | 1.1 | 0.3 |
| D3 | 3.0 | 18.7 | 0.5 | 0.3 |
| | MEAN | 21.9 | 1.0 | 1.6 |
| | STD DEV | 8.6 | 0.8 | 1.4 |

| | | | |
|---|---|---|---|
| 95% Confidence Interval | 4.84 | 0.45 | 0.80 |

### Example 9

### SEM Investigation of Slurry Cleaning Protocol Using Segment II-E

After rinsing with purified, sterile water as described above in Example 3, each biofilm-coated sub-segment of II-E was treated as follows:

II-E-1 with established biofilm thereon was fixed and prepared as described in an Example 16 below for SEM investigation.

II-E-2 was connected to II-E-3 and the resulting two-sub-segment assembly was subjected to cleaning by flowing slurry (2%) through it as described above in Example 6.

After subjecting it to the slurry-cleaning protocol, II-E-2 was disconnected from II-E-3, rinsed with sterile, 18-megohm water as described in Example 3 and then fixed and prepared for SEM investigation using the SEM protocol set out in Example 16 below.

After treatment by the slurry-cleaning protocol, II-E-3 was subjected to a flowing stream of sterilized tap water at a flow rate of 150 ml/hr for three days in an attempt to re-establish biofilm. Such biofilm could have formed by growth/multiplication of possibly lingering bacteria that had not been removed from the interior of II-E-3 by the slurry-cleaning protocol.

After treatment by flowing sterile tap-water as mentioned just above, sub-segment II-E-3 was fixed and prepared for SEM investigation using the protocol described below in Example 16.

### Example 10

### SEM Evaluation of Established Biofilm on Sub-Segment II-E-1

SEM investigation of sub-segment II-E-1 (established biofilm before cleaning) revealed a relatively uniform coating by biofilm on the inner surface of the tubing. PA bacteria and extracellular biofilm matrix were clearly visible.

### Example 11

### SEM Evaluation of Sub-Segment II-E-2 After Cleaning Using 2% Slurry According to the Present Invention

SEM investigation of sub-segment II-E-2 showed that biofilm had been thoroughly removed from this sub-segment that had been cleaned using 2% slurry. The inner wall of the entire sub-segment was very clean. Careful investigation by SEM of the entire inner wall surface of sub-segment II-E-2 uncovered no bacteria and only two isolated instances of what appeared to be lingering biofilm matrix (2 patches, each of about 50 sq microns in area, as compared to a total wall area of about 56 million sq microns). The SEM protocol is descibed in Example 16.

### Example 12

### SEM Investigation of Attempt to Re-Establish Biofilm on Surface of Sub-Segment II-E-3 Cleaned Using Particle Suspension According to the Present Invention

This sub-segment (II-E-3) had the following history. Firstly, biofilm was established on the inner tubing wall as explained in Example 3 above. Next, the established biofilm was cleaned using slurry according to the present invention to remove biofilm as described in Example 9. Following cleaning, it was subjected to flowing, pre-sterilized tap water in an attempt to permit the reformation of biofilm from any viable bacteria that might have remained on the cleaned surface as described in Example 9. After the attempted re-formation of biofilm, the entire surface of sub-segment II-E-3 was investigated by SEM in order to try to find evidence of bacteria or biofilm matrix on the surface. No evidence of bacteria or matrix material was found. Some particles not of microbial morphology were evident on the surface and these are believed to be mineral matter deposited by the sterilized tap water. This tap water from the Wallingford Conn. municipal distribution network is a mixture of well- and surface water and contains significant mineral content (chloride 24-40 ppm, sodium 13-64 ppm, sulfate 17-19 ppm). We conclude that no bacterial or biofilm re-growth occurred on sub-segment II-E-3. This suggests that the inventive slurry treatment cleaning protocol removed established biofilm to produce a sterile tubing surface. It is noteworthy that Meiller et al. (1999) reported that sanitizing agents such as hypochlorite, acetaldehyde and alcohol failed to remove matrix material from DUWL tubing in their experiments, and that the residual, lingering matrix material appeared to accelerate subsequent re-growth of biofilm in the DUWL tubing. Meiller et al. (1999) also raised the issue of whether chemical sanitizing agents could become trapped in the lingering biofilm matrix in DUWLs and thus represent an additional threat to dental patients.

### Example 13

### Treating Established Biofilm by a Cleaning Protocol Using Hypochlorite Solution

Because hypochlorite is known to interfere with chemiluminescence measurements, experiments using hypochlorite as cleaning agent were confined to SEM observations of biofilm. A PA biofilm was established over a seven day period in a separate, 50-inch length of tubing using the same procedures as described in Examples 1 and 2 above. This length of tubing (Length IV) was separate and different from tubing Lengths I, II and II used in previous examples. Following protocols already explained in Example 3 above, a single, upstream, 3.75-inch segment (herein designated segment IV-F) was cut from the tubing, subdivided into sub-segments IV-F-1, IV-F-2, and IV-F-3, re-assembled and rinsed with pure, sterile water. Sub-segment IV-F-1 was fixed and prepared for SEM investigation of the biofilm established using the SEM protocol set forth below. Sub-segments IV-F-2 and IV-F-3 were then connected together and subjected to cleaning by pumping therethrough a solution of sodium hypochlorite (0.525%) prepared by diluting 1 volume of household bleach (5.25%) with 9 volumes of pure, sterile water. This approximate concentration of hypochlorite is equal to, or greater, than concentrations that have been widely used in efforts to control biofilm as reported in the literature (Williams et al. 1995; Anderson et al. 1990; Karpay et al. 1999, Meiller et al. 1999). The flow rate of hypochlorite solution through the tubing in this Example was 450 ml/hr, the same flow rate as used for the particle suspensions employed in the inventive cleaning protocol. (See Example 6 above).

### Example 14

### SEM Investigation of Cleaning Protocol Using Hypochlorite Solution

Biofilm that was established on sub-segment IV-F-1 substantially covered the entire surface of the inner tubing wall. The appearance of the biofilm and associated bacteria before cleaning was essentially the same as described in Example 10 above for the biofilm that had been established in Segment II-E.

After cleaning with hypochlorite solution, some parts of the surface of Sub-segment IV-F-2 had somewhat less biofilm than IV-F-1, but the surface of IV-F-2 generally was typically populated by matrix material and by formed bodies typical of PA morphology. These results are in substantial agreement with observations reported by others (Meiller et al. 1999) that cleaning with hypochlorite solution does not completely remove biofilm matrix material. The SEM investigation herein revealed remnants of PA bacteria remaining on the tubing wall of sub-segment IV-F-2 after treatment with hypochlorite solution in this example. Some of these remnants seemed to have altered shape or size, whereas others did not show significant changes as a result of the contact with hypochlorite solution. No chemiluminescence measurements were made on hypochlorite treated biofilm because of the recognized interference from that reagent on the chemiluminescent assay.

### Example 15

### Effect of Cleaning on Walls of Polyurethane DUWL Tubing

The smooth and regular surface of the inside wall of the original polyurethane tubing was not visibly altered by inventive cleaning procedures employing particle slurry, based on SEM investigation of the surfaces. A similar statement can be made for the cleaning protocol using hypochlorite solution.

### Example 16

### Protocol for Scanning Electron Microscopy (SEM)

Each sub-segment of tubing (1.25 inch) was fixed for 2 hours in 2% glutaraldehyde in 0.1 M Hepes buffer solution followed by rinsing in double distilled water three times, (each for 15 min.). Thereafter, the sub-segments were stored in 0.1 M Hepes buffer at 4° C., prior to further processing and analysis at an SEM laboratory.

At the SEM laboratory, the samples were fixed in chilled 1% OsO4 in 0.1M Hepes buffer overnight, then washed in chilled distilled MilliQ- filtered H₂O three times for 15 minutes each. Next, they were dehydrated by sequential immersion in chilled aqueous solutions of 30, 50 and 70% ethanol (ETOH) then in 95 and 100% ETOH at ambient temperature. All ETOH solution changes were 2 times at 30 minutes each. The samples remained in 100% ETOH overnight. The tubing samples in 100% ETOH were cut axially into two approximately congruent pieces and then critical point dried for 3 hours in a Polaron E3000 critical point dryer. Samples were mounted for SEM on Al holders with Ag paint and sputter coated with approximately 100 Angstroms of AuPd in a Polaron E5100 sputter coater. SEM was performed in a Zeiss DSM982 Gemini FESEM.

### Example 17

Clogging Phenomena No clogging was observed when slurries of particles (size<100 micron) in water were used to remove biofilm by pumping the slurry through standard PU dental line tubing (1.5 mm i.d.). Furthermore, no clogging was observed with these slurries even when a restriction was placed in the tubing that blocked more than 50% of the cross sectional area of the tubing. It was found that tendency to clog was sensitive to particle size: clogging was observed using particle sizes of 180 microns in the restricted tubing, provided the restriction was in a horizontal section of the tubing. Particles of 180-micron diameter did not clog the restriction if the tubing was in the vertical orientation. Clogging can be avoided by using smaller particles. Published engineering correlations (e.g., Oroskar and Turuian 1980) regarding critical velocity for transport of slurries of particles in tubing predict that the tendency of the particles to fluidize and move through the conduit depends on particle buoyancy in the liquid, as well as on particle size. Thus it would appear that the flow rate 450 ml/min did not cause the critical velocity of 180 micrometer particles to be exceeded in the 1.5 mm i.d. tubing.

Literature References

A-dec. 1995. Owner's Guide.

An and Friedman. 1997. J. Microbiol. Methods 30:141-152.

Anderson R. L. , Holland B. W. , Carr J. K. , Bond W. W. , Favero M. S. 1990. Effect of disinfectants on pseudomonads colonized on the interior surface of PVC pipes. AJPH 80:17-21.

Bagga, Murphy, et al. 1984. JADA 109:712-716.

Barbeau, Tanquay, et al. 1996. Appl. Env. Microbiol. 62:3954-3959.

Beachy. 1981. Journal of Infectious Disease 143:325-345.

Bergamini, Bandyk, et al. 1989. J. Vasc. Surg. 9:665-670.

Boyd and Charkrabarty. 1995. J. Ind. Microbiol. 15:162-168.

Costerton, Cheng, et al. 1987. Ann. Rev. Microbiol. 41:435-464.

Costerton, Lewandowski, et al. 1995. Ann. Rev. Microbiol. 49:711-745.

CRA. 1997. Clinical Research Associates Newsletter 23:1-3.

Davies, Chakrabarty, et al. 1993. Appl. Env. Microbiol. 59:1181-1186.

DeBeer, Srinivasan, et al. 1994. Appl. Env. Microbiol. 60:4339.

Drury, Stewart, et al. 1993. Biotech. Bioeng. 41:111-117.

Fayle and Pollard. 1996. Br. Dent. J. 181:369-372.

Fotos, Westfall, et al. 1985. J. Dent. Res. 64:1382-1385.

Gristina and Costerton. 1984. Orthop. Clin. North Am. 15:517-535.

Jacqueline, LeMagrex, et al. 1994. Pathologic Biologie 42:425.

Karpay R. I. , Plamondon P. J. , Mills S. E. , Dove S. B. 1999. Combining periodic and continuous sodium hypochlorite treatment to control biofilms in dental unit water lines. JADA 130: 957-965.

Kelstrup, Funder-Nielson, et al. 1977. Acta Pathologia y Microbiologia of Scandivia, Series B 85:177-183.

Massol-Deya, Whallon, et al. 1994. ASM News 60:46.

McCabe, Smith, et al. 1985. Unit Operations of Chemical Engineering. McGraw Hill, New York.

McDaniel and Capone. 1985. J. Microbiol. Methods 3:291-302.

Meiller T. F. , DePaola L. G. , Kelley J. I. , Baqui A. A. , Turng B. -F. , Falker W. A. 1999.

Dental unit water lines: biofilms, disinfection and recurrence. JADA 130: 65-72

Mills S. E. 2000. The dental unit waterline controversy. JADA 131: 1427-1441

Moussa, Gainor, et al. 1996. Clin. Orth. Rel. Res. 329:255-262.

Oroskar and Turian. 1980. AIChE J. 26:550-558.

Qian, Stoodley, et al. 1996. Biomaterials 17:1975-1980.

Shearer. 1996. JADA 127:181-189.

Tall B. D. Williams H. N. George K. S. Gray R. T. Walch M. 1995 Bacterial succession within a biofilm in water supply lines of dental air-water syringes. Can J. Microbiol. 41:647-654

Tang and Cooney. 1998. J. Ind. Microbiol. 20:275-280.

Tollefson, Bandyk, et al. 1987. Arch. Surg. 122:38-43.

Vandevivere and Kirchman. 1993. Appl. Env. Microbiol. 59:3280-3286.

Walker J. T. Bradshaw D. J. Bennett A. M. Fulford M. R. Martin M. V. Marsh P. D. 2000 Microbial biofilm formation and contamination of dental-unit water systems in general dental practice. Appl. Envir. Microbiol. 66: 3363-3367

Wellman, Fortun, et al. 1996. Antimicrobial Agents and Chemotherapy 40:2012-2014.

Williams H. N. , Baer M. L. , Kelley J. I. 1995. Contribution of biofilm bacteria to the contamination of the dental unit water supply. JADA 126: 1255-1260.

Williams, Baer, et al. 1995. JADA 126:1-6.

Williams, Kelley, et al. 1994. JADA 125:1205-1211.

Williams, Johnston, et al. 1993. JADA 124:59-65.

Scope

Although the foregoing description of the invention contains many specific details, these should not be construed as limiting the scope of the invention, but merely as providing illustrations of some of the presently preferred embodiments of this invention. For example, a preservative can be added to the suspensions employed in the present invention in order to hinder microbial growth therein during storage without departing from the spirit and scope of the invention. Also, a biocide can be added to the suspensions in order to kill microorganisms or attenuate microbial activity of biofilm fragments after they are removed from a surface according to the invention. Moreover, the fluid used to form a suspensions employed in the invention can be a gas or a liquid. Furthermore suspensions can be employed that comprise mixtures of particles of different sizes, different densities, different hardness, different shapes and composed of different materials. In addition the invention can be used to select microorganism according to their tenacity of attachment to a surface; the less strongly attached microorganisms will be removed faster or with smaller flow velocities or lower turbulence, while the more tenaciously attached will be removed more slowly, or only with greater flow velocity or greater turbulence. The scope of the invention should be determined by the appended claims and their legal equivalents, rather than by the examples and particularities set out above.

What is claimed is:

1. A composition for removing biofilm from a surface comprising essentially a suspension of solid particles in a fluid, the concentration of said particles in the fluid being in the range of about 0.01 to 20% by weight.

2. The composition according to claim 1 wherein the ratio of density of the particles to density of the fluid is about 0.3 to 3.0, said densities being expressed in the same units.

3. The composition according to claim 2 wherein the density of said particles is within the range of about 0.5 to 3.0 grams per cubic centimeter.

4. The composition according to claim 1 wherein the size and density of said particles and the density of said fluid are chosen so that the critical velocity for entrained flow of said particles in said fluid is exceeded when the suspension flows in a tubular conduit at a Reynolds number that exceeds about 100.

5. The composition according to claim 2 wherein the liquid is water.

6. The composition according to claim 2 wherein the particles are softer than the surface.

7. The composition according to claim 5 wherein the particles are of a material chosen from the group consisting of acrylic resin, ADGC resin, UF resin, sodium bicarbonate, gypsum, calcite, gibbsite, talc and gypsum.

8. A method for removing biofilm from a surface comprising:
(a) providing a suspension of solid particles in a fluid, said particles being smaller than about one millimeter,
(b) causing said suspension to flow in contact with said surface but not normal to said surface, thereby removing at least a portion of said biofilm from said surface into said fluid,
(c) conducting the fluid containing the removed biofilm away from said surface.

9. The method according to claim 8 wherein said surface is the inside wall of a conduit, said flow is within said conduit, the flow condition is turbulent and the flow velocity equals or exceeds that required for entrainment of the largest of said particles in said fluid

10. The method according to claim 9 wherein the suspension is a slurry of particles in liquid.

11. The method according to claim 10 wherein the liquid is aqueous.

12. The method according to claim 11 wherein said suspension flows in contact with said surface for a time period between about three seconds and thirty minutes.

13. The method according to claim 11 wherein the concentration of said particles in the suspension is in the range of about 0.01 to 20% by weight.

14. The method according to claim 11 wherein the particles employed are softer than the surface.

15. Apparatus for removing biofilm from a surface of a solid comprising a solid article having a surface on which biofilm can accumulate, container means, a suspension of solid particles within a fluid, said suspension held within said container means, pumping means for pumping said suspension from said container means into conduit means for directing a flow of said suspension in contact with said surface, the direction of said flow being parallel to said surface or at an oblique angle to said surface.

16. Apparatus according to claim 15 wherein the suspension is a slurry of particles in a liquid.

17. Apparatus according to claim 16 wherein the liquid is aqueous.

18. Apparatus according to claim 17 wherein said surface is the inside wall of a conduit.

19. Apparatus according to claim 16 wherein the concentration of said particles in the suspension is in the range of about 0.01 to 20% by weight.

20. Apparatus according to claim 16 wherein the ratio of density of the particles to density of the fluid is about 0.3 to 3.0, said densities being expressed in the same units.
